(19) United States
(12) Patent Application Publication
(10) Pub. No.: US 2007/0024048 A1
(43) Pub. Date: Feb. 1, 2007

(54) Scrapbook Component System Which Includes Cover Insert

(75) Inventor: Michael C. Akin, Fairhaven, MA (US)

Correspondence Address: RANKIN, HILL, PORTER & CLARK, LLP, 925 EUCLID AVENUE, SUITE 700, CLEVELAND, OH, 44115-1405, US

(73) Assignee: THE CHILCOTE COMPANY, Cleveland, OH (US)

(21) Appl. No.: 11/161,282

(22) Filed: Jul. 28, 2005

(51) Int. Cl. B42D 1/08

(52) U.S. Cl. 281/22

(57) ABSTRACT

A scrapbook component customizing system includes a scrapbook cover having a cavity and a group of interchangeable inserts that may alternatively be placed in the cavity to customize the appearance of the scrapbook according to the contents of the book. The system provides a variety of different inserts to allow for many different possible finished scrapbook appearances, and the size, shape and design of the inserts is coordinated with the scrapbook cover so that the scrapbook presents a pleasing finished appearance when the selected insert is installed.

### FIELD OF THE INVENTION

The present invention relates to the design of scrapbooks, and, more specifically, to a scrapbook component system in which the cover appearance may be changed by the user of the scrapbook.

### BACKGROUND OF THE INVENTION

Scrapbooking is a general term used to describe creative methods of displaying images, typically photographs. Scrapbooking techniques include dedicating individual pages of a multipage album or folio to one or more photographs along with complementary keepsakes and other items of memorabilia. Among the items often kept in scrapbooks are clippings, postings, stickers, and other items of text, as well as cut-up portions of other photographs and/or sketches as well as background color shading and items providing a textural effect such a yarn, felt pieces etc. The complementary devices often relate to and enhance the subject matter of the image. An individual's creativity allows the user to personalize each scrapbook page. In addition to individual pages, the scrapbook cover is often also personalized by the artist with photos, drawings or other visual devices.

Since the materials preserved in a scrapbook usually have special significance, and since the materials may be one-of-a-kind unique items, it is often important that the scrapbook present them with a high-quality appearance, preferably similar to that of a professionally prepared album. For example, merely pasting or gluing photographs or other items onto the cover the scrapbook often presents an amateurish appearance. However, it is usually difficult to provide a custom finished appearance to the scrapbook cover while maintaining the desired flexibility so that the scrapbook can be adapted for each particular application.

In the past, photograph albums have been proposed where one or more photos may be displayed within a frame attached to the album cover. In some cases the frame is attached to the front of the album and may be removed in order to change the picture within and then returned to the album cover. However, the frame functions solely to hold the photograph in place, and is not intended as a design element in the appearance of the album cover. Furthermore, the album cover cannot be used without a photograph, as the cover would present a distinct unfinished appearance.

What is desired is a way to be able to change the cover of a scrapbook according to the theme of a scrapbook by varying the visual devices, beyond just pictures, and to provide the person creating the scrapbook with a variety of design options so that the scrapbook can be customized for a particular theme or event.

### SUMMARY OF THE INVENTION

Shortcomings, such the lack of device variety disclosed by the prior art are overcome by the present invention. The present invention provides a system of numerous display elements that can be selectively used to customize the appearance of a single scrapbook cover. As a result there is no need to replace the entire scrapbook when only its theme is to be changed.

In accordance with the present invention, consumers can chose a design or theme consistent with the specific theme or event for which the scrapbook is being used, and customize the appearance of the scrapbook in accordance with that design or theme by selecting an special insert for the front cover the scrapbook, and, if desired, including a special photograph or other item along with the insert.

The present invention provides a system in which a number of display variations may be available to the user who can customize the appearance of the scrapbook cover in accordance with the purpose for which the scrapbook is being used. A special photograph or other design, or a special keepsake, can be displayed on the scrapbook cover, and the appearance surrounding the photograph can be customized depending upon the wishes of the user. A plain frame can be used, or a frame that blends with the scrapbook cover. Alternatively, a frame can be used which contrasts with the scrapbook cover or carries a desired theme to which the scrapbook is devoted.

The scrapbook component system of the present invention is intended to present on the scrapbook cover a wide variety of different inserts, each of a different material, color or design. This allows the user to customize the front cover of the scrapbook to match the contents or some other desired theme. Inserts can be used to frame a photograph or other visual element. Inserts can also be used to present a theme such as a wedding or birth. Furthermore, inserts can be used solely to provide a desired color theme to the scrapbook and the colors or designs on the inserts may be used to adorn the pages of the scrapbook to carry the design or theme throughout the scrapbook.

The inserts used with the scrapbook cover of the present invention are also preferably removable and replaceable, so that a scrapbook can be reused with a different theme if desired.

These and other advantages are provided by the present invention of a scrapbook component system comprising a scrapbook cover having a front display surface defining a cavity; and a set of at least two display inserts having equivalent outside dimensions, each insert alternately positionable within the cover cavity.

### BRIEF DESCRIPTION OF THE DRAWINGS

FIG. 1 is a perspective view of a scrapbook component system including a scrapbook with a cover and three different inserts;

FIG. 2 is a perspective view of the scrapbook cover of FIG. 1 without any inserts;

FIG. 3 is a side sectional view of the scrapbook cover of FIG. 2;

FIG. 4 is a perspective view of a scrapbook cover of FIG. 2 with a first type of insert in place;

FIG. 5 is a side sectional view similar to FIG. 3 of the scrapbook cover of FIG. 4 with the insert in place;

FIG. 6 is a perspective view similar to FIG. 4 of a scrapbook cover with a second type of insert in place; and

FIG. 7 is a perspective view similar to FIGS. 4 and 5 of a scrapbook cover with a third type of insert in place.

### DETAILED DESCRIPTION OF THE INVENTION

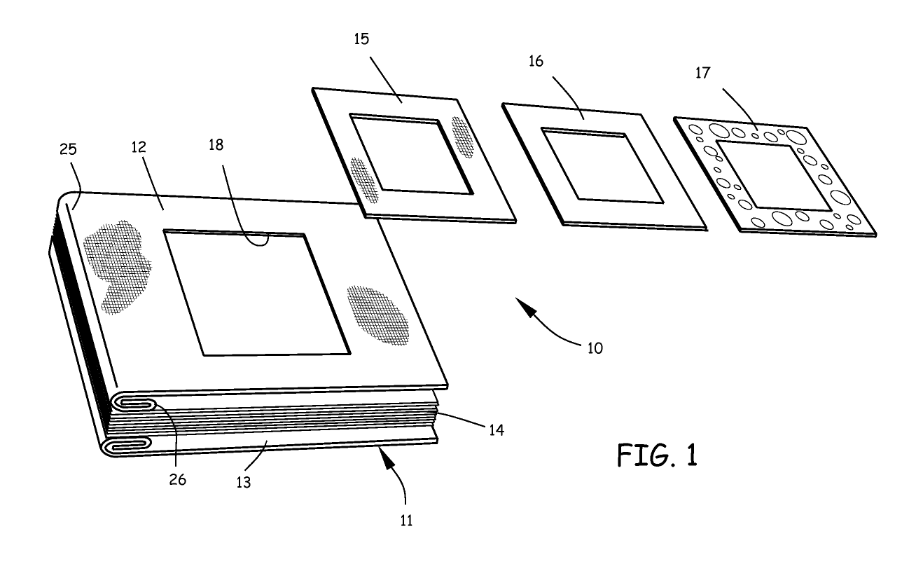

Referring more particularly to the drawings, and initially to FIG. 1, there is shown a scrapbook component system 10 according to the present invention. The scrapbook component system 10 comprises a scrapbook 11 having front and back covers 12 and 13 with a plurality of scrapbook leafs or pages 14 bound between the covers, and a selection of different separate inserts 15, 16 and 17. Any of the inserts 15, 16 or 17 is designed to fit within a cavity 18 formed in the front scrapbook cover 12 and may be easily swapped with another insert as desired.

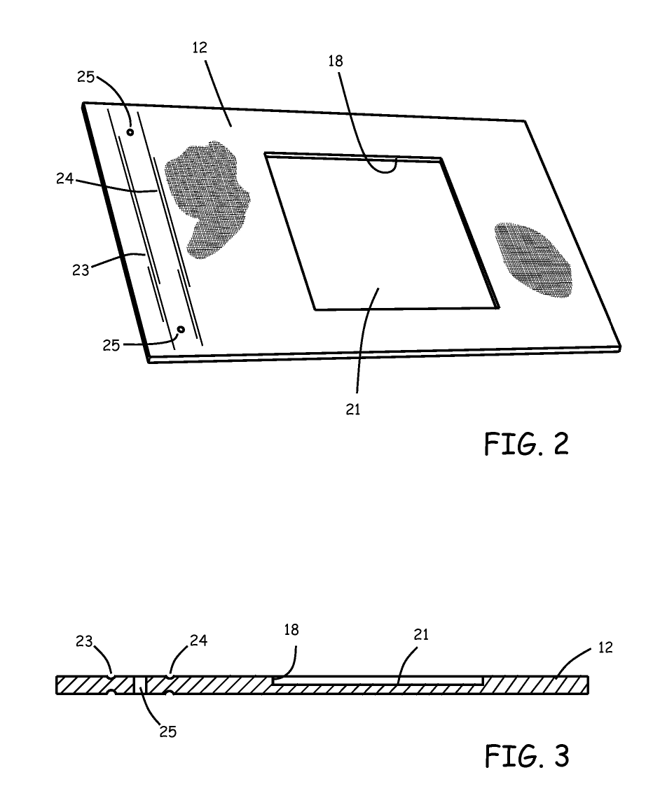

The front cover 12 of the scrapbook, without any inserts in place, is shown in more detail in FIGS. 2 and 3. The scrapbook front cover 12 is preferably comprised of a rectangular piece of cardboard or paper board or other industry standard material, forming a stiff structural core. The outer surface of the front cover 12 may be covered in book binding materials, fabric, or other desired decorative material. The inner surface (not shown) of the front cover 12 may be covered with a paper liner so the cardboard or paper board core is not exposed. The outer surface of the front cover 12 has a recess or cavity 18 formed therein. The cavity 18 may be formed by a die cutting process, as is well known in the art. The cavity 18 is cut into the outer surface of the cardboard or paper board of the front cover 12, but not all the way through, so that the cardboard core supplies structural support for the front cover at the location of the cavity. Preferable, the cardboard core of the front cover 12 is formed of multiple plies of cardboard or paper board material, and the cavity is die cut in only the outer ply, leaving one or more inner plies to provide the structure core for the cover. As shown, the cavity 18 has a square shape, but it may be formed in any desired shape. The exposed outer surface 21 within cavity is covered with a paper liner to protect the cardboard core. Both the book binding material and paper liners provide good wear resistance and provide a pleasing esthetic appearance to the finished scrapbook.

As shown in the preferred embodiment of the scrapbook in the drawings, each of the scrapbook covers 12 and 13 have a pair of parallel creases to allow the covers to hinge when the scrapbook is opened and to provide for the binding of the covers together along with the scrapbook pages 14. The front cover 12 has a pair of parallel creases 23 and 24 as shown in FIGS. 2 and 3. Similar creases are provided in the back cover 13. The creases 23 and 24 allow one end of the cover to be folded under as shown in FIG. 1, and to allow the covers to be hinged to lie flat when the scrapbook is opened. A pair of apertures 25 are provided at one end between the creases 23 and 24 to provide for the passage of fasteners (not shown) such as a binding screws and nuts for holding the scrapbook leaves 14 and for holding the covers 12 and 13 together on each side. By providing for the folding of the end of the scrapbook cover along the pair for creases 23 and 24, the binding screws and nuts or other fasteners are hidden from view when the scrapbook is closed. Other types of bindings may be used for the scrapbook, such as loose-leaf bindings or any of other known binding techniques used in making scrapbooks or photo albums.

The scrapbook component system 10 includes a plurality of different inserts 15, 16 and 17 that may be selectively inserted into the cavity 18 formed on the outer surface of the front cover 12. The inserts are preferably of different types, allowing the user to select the type of insert for the particular application for which the scrapbook is being designed by the user.

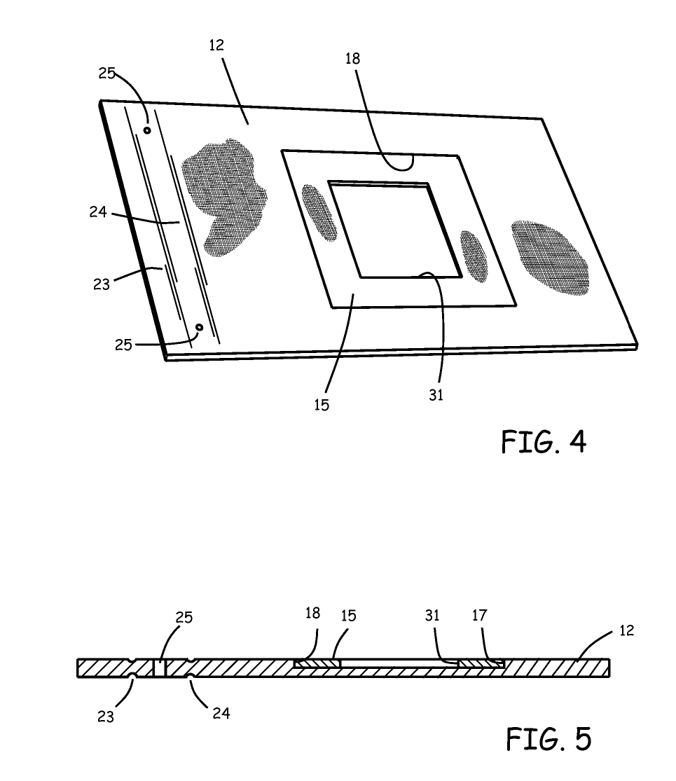

A first type of insert 15, as shown in detail in FIG. 4, functions as a frame for a photograph, drawing, keepsake or item desired to be displayed on the front cover 12 of the scrapbook. The insert 15 has an exterior peripheral shape conforming to the interior shape of the cavity 18, and defines an interior aperture 31 having a shape that may be the same or different from the exterior peripheral shape of the insert. As shown in FIG. 3, the insert 15 has both a square exterior peripheral shape and a square aperture shape. A photograph may be placed in the cavity 18 between the insert 15 and the cover 12, such that it will be held in place by the insert, and the insert will provide a frame for the photograph. The thickness of the insert 15 is approximately the same as the depth of the cavity 18, so that, when the insert 15 is installed in the cavity 18, the scrapbook cover and insert assembly provides a level outer surface. Preferably, the insert 15 is made of or covered with same material as the scrapbook cover, such as book binding material.

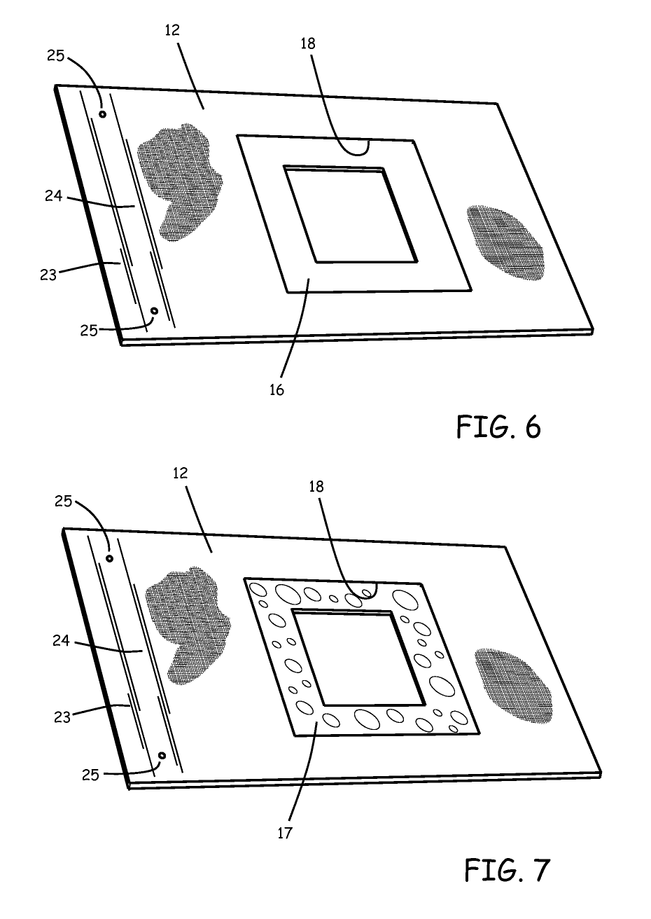

Alternatively, the insert may be made from and/or covered with a contrasting material to provide a different texture to a portion of the scrapbook cover. The insert 16 shown in FIG. 6 is provided with a different coordinating color and/or texture from that of the scrapbook cover. The insert 16 may be provided with a central aperture of any shape for the display of a photograph or other item, or it may be solid and continuous without any aperture.

A third type of insert 17, shown in FIG. 7, comprises a theme display in order to customize the scrap book to a particular theme such as “Baby Boy”, “Baby Girl”, “Graduation”, “Wedding”, “Vacation”, or the like. The themed insert 17 may include a central aperture similar to the insert 15 for a photograph or other visual display, or the insert 17 may be solid without an aperture to serve as a title block appearing on the scrapbook cover. As shown in FIG. 7, the insert 17 is directed with a series of polka dots, but any other decoration may be used with symbols or illustrations emphasizing a particular theme. The design appearing on the insert 17 may also be provided on scrapbook pages sold to the user who can then use the same design elements throughout the scrapbook.

Other types of inserts are possible. For example, the insert may take the form of a jacket or holder for a compact disc. The insert may be provided with a slit from which the compact disc may be removed, or the insert may be in the form similar to a “jewel case” commonly used to store compact discs. The disc may include picture files, or music files pertaining to the subject matter of the scrapbook. Another type of insert may be a raised display case for storing a displaying a three-dimensional object, such as a lock of hair, a fabric swatch or other keepsake.

The insert 15, 16 or 17 may be held in place by providing the exterior dimensions of the insert to be the same or even slightly larger than the dimensions of the cavity, so that the insert will fit very snugly within the cavity when it is installed and the insert will not be not prone to falling out if the scrapbook is jarred or dropped. The insert could be pried out of the cavity and replaced with a different insert if it is desired to reuse the scrapbook with a different theme or appearance. Alternatively, the insert may be secured within the cavity by applying a layer of adhesive to the inside of the cavity. The adhesive layer can be covered with a removable protective plastic sheet which is removable when the insert is installed. The use of an adhesive would generally prevent the replacement of the insert after the insert has been installed, unless the adhesive is of the type used on removable memo notes. Other means may be used to secure the insert onto the scrapbook cover such as glue or tape.

The scrapbook of the present invention may be marketed as a complete component system with a scrapbook containing the leafs bound within the covers and a selection of different inserts which can be interchangeably combined with the front cover of the scrapbook to provide a finished scrapbook having the desired appearance. Alternatively, the system may be sold as individual components in which the purchaser buys the covers and pages each having the desired colors, sizes and materials, and then selects one or more inserts for use with the cover, depending upon how the scrapbook will be used. The customer would then have the option of purchasing additional inserts, if he or she decides to change the theme or appearance of the scrapbook.

Alternatives

The scrapbook cover 12 is shown having a rectangular shape, but may have any shape, such as square or having generally rectangular with curved sides. The scrapbook cover 12 is shown covered with book binding material and paper, but may be covered with any durable material, such as leather, imitation leather, fabric, plastic, paper, metal foil, etc. The cavity 18 defined by the scrapbook cover 12 is shown having a square shape, but may be any shape including rectangular, circular or oval.

It is also possible to provide an insert which is merely in the shape of the scrapbook cover cavity without any aperture and made of the same material and color as the album cover. When such an insert is inserted into the cavity, the album has a continuous unadorned front cover without any identifying theme or decoration. Such a cover may be used in those circumstances in which a decorated front cover is undesirable. Furthermore, the scrapbook may be sold with such an insert in place, to allow the user to substitute a different insert as desired.

The scrapbook system of the present invention contemplates a scrapbook having a front cover that can accommodate various different inserts, with a variety of inserts being available to the consumer to allow the consumer to customize the appearance of the scrapbook. The inserts may be available for purchase separately or they may be available as part of kit in which the scrapbook is sold with a variety or different inserts. In addition, the invention contemplates that scrapbook pages may be selected by the consumer to further customize the appearance of the scrapbook. Pre-printed designs may appear on scrapbook pages provide as part of the scrapbook component system of the present invention, and such pre-printed designs may match the designs on the cover inserts, or they may be designed to complement and coordinate with the designs on the cover inserts.

Advantages

The scrapbook cover system 10 of the present invention provides a selection of numerous inserts 15, 16 and 17 that may be installed to form part of the cover 10 and provide a pleasing finished appearance to the scrapbook, while the scrapbook can be customized to present a desired theme for the scrapbook contents. Any single insert may be removed and replaced with another insert from the system. The inserts customize the scrapbook, and thus, the information inside is easily identified.

Although the invention has been shown and described with reference to certain preferred and alternate embodiments, the invention is not limited to these specific embodiments. Minor variations and insubstantial differences in the various combinations of materials and methods of application may occur to those of ordinary skill in the art while remaining within the scope of the invention as claimed and equivalents.

What is claimed is:

1. A scrapbook component system comprising:
a scrapbook cover having a front display surface defining a cavity; and
a set of at least two display inserts having equivalent outside dimensions, each insert alternately positionable within the cover cavity.

2. The scrapbook component system of claim 1, wherein the outside dimensions of the at least two display inserts are generally equivalent to the outside dimension of the cavity defined by the scrapbook cover.

3. The scrapbook component system of claim 1, wherein the thickness of the at least two display inserts are generally equivalent to the depth of the cavity, so that when one of the inserts is positioned within the cavity, the scrapbook cover and insert assembly provides a generally level outer surface.

4. The scrapbook component system of claim 1, wherein at least one of the display inserts has a frame shape defining an interior opening for viewing a photograph or other visual representation.

5. The scrapbook component system of claim 1, wherein the scrapbook cover and a least one of the display inserts are covered with the same material.

6. The scrapbook component system of claim 5, wherein the scrapbook cover and at least one of the display inserts are of different colors.

7. The scrapbook component system of claim 1, wherein at least one of the display inserts is decorated with a pattern or indicia.

8. The scrapbook component system of claim 7, comprising in addition a plurality of scrapbook pages bound to the cover, wherein at least one of the pages has a decoration pattern or indicia which matches that of the display inserts.

9. The scrapbook component system of claim 1, wherein the set of display inserts includes:
an insert having a frame shape defining an interior opening for viewing a photograph or other visual representation, and
an insert that is continuous without an interior opening.

10. A scrapbook cover system comprising a set of at least two display inserts having equivalent outside dimensions, each display insert alternately positionable within a cavity defined by a scrapbook cover.

11. A scrapbook component system comprising:
a scrapbook comprising a front cover, a back cover, and a plurality of pages bound between the front and back covers, the front cover having a front display surface defining a cavity; and
a set of at least two display inserts having equivalent outside dimensions, each insert alternately positionable within the cover cavity.
